(19) United States
(12) Patent Application Publication
(10) Pub. No.: US 2002/0004726 A1
(43) Pub. Date: Jan. 10, 2002

(54) System for human tissue recovery

(76) Inventors: Russell S. Donda, Alachua, FL (US); Jamie M. Grooms, Alachua, FL (US); Nancy Holland, Alachua, FL (US)

Correspondence Address: Gerard H. Bencen, Bencen & Van Dyke, P.A., 1630 Hillcrest Street, Orlando, FL, 32803, US

(21) Appl. No.: 09/843,611

(22) Filed: Apr. 26, 2001

Related U.S. Application Data
(60) Provisional application No. 60/200,159, filed on Apr. 26, 2000.

(51) Int. Cl. G06F 17/60

(52) U.S. Cl. 705/2

(57) ABSTRACT

This invention provides a system for efficient recovery of human tissue for processing by a tissue processing facility or tissue bank entity. According to this system, a tissue processing facility establishes a management services agreement (MSA) with a tissue recovery agency under which all of the operating costs and procedures of the tissue recovery agency are provided for by the tissue processing facility. In this manner, the efficiency of the tissue recovery facility is maximized such that substantially all of the resources of the tissue recovery facility may be devoted to the task of recovering essential and precious human tissue materials. The administrative burdens of per donor charges and the like are thus alleviated, to the mutual benefit of the tissue processing facility and the tissue recovery facility.

### CROSS REFERENCE TO RELATED APPLICATIONS

This application is a non-provisional regular filing based on provisional application Ser. No. 60/200,159, filed Apr. 26, 2000, from which priority is hereby claimed under 35 U.S.C. SECTION 120.

### FIELD OF THE INVENTION

This invention relates to the field of human tissue recovery and processing for implantation into recipients in need thereof.

### BACKGROUND OF THE INVENTION

Typical human tissue recovery agencies are for-profit or not-for-profit corporations that normally recover and send human tissue to a tissue processing facility or other tissue bank related entity, for processing into allograft for human implant. The processing facility typically distributes the prepared allograft tissue. In addition, the recovery agency normally seeks reimbursement from the processing facility for recovery services performed, on a donor-by-donor basis.

### SUMMARY OF THE INVENTION

This invention provides a system for efficient recovery of human tissue for processing by a tissue processing facility or tissue bank entity. According to this system, a tissue processing facility establishes a management services agreement (MSA) with a tissue recovery agency under which all of the operating costs and procedures of the tissue recovery agency are provided for by the tissue processing facility. In this manner, the efficiency of the tissue recovery facility is maximized such that substantially all of the resources of the tissue recovery facility may be devoted to the task of recovering essential and precious human tissue materials. The administrative burdens of per donor charges and the like are thus alleviated, to the mutual benefit of the tissue processing facility and the tissue recovery facility.

Accordingly, it is an object of this invention to provide a system for human tissue recovery which is more efficient than existing methods of tissue recovery from a method of doing business perspective.

Further objects and advantages of this invention will be appreciated from a review of the complete disclosure and the appended claims.

### DETAILED DISCLOSURE OF THE INVENTION

In lieu of reimbursement for recovery services on a donor-by-donor basis, under a “Management Services Agreement”, or “MSA”, we have found that it is more efficient to provide tissue recovery agencies with the funding and management services necessary to operate its recovery agency in its entirety. In one method of carrying out this system, funding is provided through a mutually agreed upon annual budget broken out quarterly. A separate checking account or the like is set up for this purpose, and funds in the account are made available to pay all of the MSA agency expenses, including payroll, tissue recovery supply expenses and the like. In addition, the system includes a method for periodically, for example quarterly, increasing or decreasing the tissue recovery agency's budget based upon the efficiency of the specific MSA agency. The MSA also includes a means for a “bonus pool” whereby a given MSA agency can earn a bonus amount for disbursement to their employees based upon the number of donors recovered and the cost of the MSA agency's recovery efforts - the more efficient the MSA agency, the larger the bonus pool amount. In this manner, the MSA agency is provided with the freedom to devote up to 100% of its time to recovery activities, because the present methodology provides administrative support and management services including but not limited to: (a) arranging office space and related services, equipment, tissue recovery and other supplies; (b) financial administration and management services including regulatory and quality assurance, donor recovery training, consulting and providing standard operating procedures and other methods of operation.

Optionally, the present system provides for representation of the processing facility or other tissue bank related entity on the Board of Directors of the MSA agency. In addition, optional features of the present system include a requirement that all MSA agency recovered tissue is provided to the specific processing facility with which the MSA is established. For handling and logistical reasons, providing all recovered tissues to a single processor is a more efficient means of operation. If the processing facility elects not to receive any particular tissues, then the system optionally provides for the MSA agency to have the right to distribute those tissues to other processing facilities.

The processing facility processes and distributes tissues recovered by a particular MSA agency and uses its best efforts to supply the implant needs of the MSA agency local community. While the MSA term may vary widely, we have found that an agreement term of between one and ten years is reasonable. Given the costs of establishing the various administrative elements of the system with a given tissue recovery agency, however, it is preferred for the term to be longer than one year. Optionally, the MSA may provide for the system to be terminated upon an agreed upon notice period.

While this disclosure provides a description of the specifics of a system for human tissue recovery, based on this disclosure, those skilled in the art will recognize that equivalents of the present system may be established which perform substantially the same function in substantially the same way to achieve substantially the same result. Such equivalents are considered to come within the scope of the present disclosure and the claims appended to this disclosure.

What is claimed is:

1. A system for human tissue recovery which comprises a tissue processing facility or other tissue bank related entity providing a tissue recovery agency with funding and management services necessary to operate said tissue recovery agency, in lieu of reimbursement for recovery services on a donor by donor basis or otherwise reimbursing costs on a basis directly related to the number of donors recovered by said recovery agency.

2. The system according to claim 1 wherein said funding and management services are provided under a “Management Services Agreement”, or “MSA”.

3. The system according to claim 2 wherein said funding is provided through a mutually agreed upon budget.

4. The system according to claim 2 wherein said funding is provided through a mutually agreed upon annual budget broken out quarterly.

5. The system according to claim 4 wherein funds are made available by said tissue processing facility or other tissue bank related entity to said tissue recovery agency to pay said tissue recovery agency expenses under said MSA.

6. The system according to claim 5 further comprising establishing a separate checking account for said tissue recovery agency.

7. The system according to claim 6 wherein said expenses include payroll and tissue recovery expenses.

8. The system according to claim 7 further comprising increasing or decreasing the tissue recovery agency's budget based upon the efficiency of the specific MSA agency.

9. The system according to claim 8 wherein said increasing and said decreasing is performed quarterly.

10. The system according to claim 9 wherein said system further comprises a means whereby said MSA agency earns a bonus amount.

11. The system according to claim 10 wherein said system further comprises a means whereby said MSA agency earns a bonus amount for disbursement to their employees based upon the number of donors recovered and the cost of the MSA agency's recovery efforts such that the more efficient the MSA agency, the larger the bonus pool amount.

12. The system according to claim 10 wherein said MSA agency is provided with the freedom to devote up to 100% of its time to recovery activities due to said tissue processing facility or other tissue bank related entity providing administrative support and management services necessary to operate said tissue recovery operation.

13. The system according to claim 12 wherein said administrative support and management services comprise: (a) arranging office space and related services, equipment, tissue recovery and other supplies; (b) financial administration and management services including regulatory and quality assurance, donor recovery training, consulting, and providing standard operating procedures and other methods of operation.

14. The system according to claim 1 further comprising securing representation of the processing facility or other tissue bank related entity on the Board of Directors of the MSA agency.

15. The system according to claim 1 further comprising requiring that all MSA agency recovered tissue is provided to the specific processing facility or other tissue bank related entity with which the MSA is established.

16. The system according to claim 15 wherein, if the processing facility or other tissue bank related entity elects not to receive any particular tissues, providing said MSA agency with the right to distribute those tissues to other processing facilities or other tissue bank related entity.

17. The system according to claim 1 wherein said processing facility processes and distributes tissues recovered by a particular MSA agency and uses its best efforts to supply the implant needs of the MSA agency local community.

18. The system according to claim 2 wherein a term of between one and ten years is established in said MSA.
